(19) United States
(12) Patent Application Publication
(10) Pub. No.: US 2018/0121733 A1
(43) Pub. Date: May 3, 2018

(54) REDUCING COMPUTATIONAL OVERHEAD VIA PREDICTIONS OF SUBJECTIVE QUALITY OF AUTOMATED IMAGE SEQUENCE PROCESSING

(71) Applicant: Microsoft Technology Licensing, LLC, Redmond, WA (US)

(72) Inventors: Neel Suresh Joshi, Seattle, WA (US); Baoyuan Wang, Redmond, WA (US); Sing Bing Kang, Redmond, WA (US)

(73) Assignee: Microsoft Technology Licensing, LLC, Redmond, WA (US)

(21) Appl. No.: 15/336,732

(22) Filed: Oct. 27, 2016

(51) Int. Cl. G06K 9/00; G06K 9/62

(52) U.S. Cl. CPC G06K 9/00744; G06K 9/6256

(57) ABSTRACT

A “Quality Predictor” applies a machine-learned quality model to predict subjective quality of an output video of an image sequence processing algorithm without actually running that algorithm on a temporal sequence of image frames (referred to as “candidate sets”). Candidate sets having sufficiently high predicted quality scores are processed by the image sequence processing algorithm to produce an output video. Therefore, the Quality Predictor reduces computational overhead by eliminating unnecessary processing of candidate sets when the image sequence processing algorithm is not expected to produce acceptable results. The quality model is trained on a combination of human quality scores of output videos generated by the image sequence processing algorithm and image features extracted from frames of image sequences used to generate those output videos. Examples of image sequence processing algorithms operable with the Quality Predictor include video looping generation algorithms, video filters, video panorama generation algorithms, etc.

### BACKGROUND

When applying typical image and video processing algorithms to automatically generate output videos from a sequence of images, the quality of the resulting video tends to vary greatly. Many existing solutions for generating these types of automated output videos operate by executing a video processing algorithm on a set of image frames and then automatically evaluating the resulting video to determine whether that output video is of sufficiently high quality. Unfortunately, such video processing algorithms tend to consume a significant amount of computational resources when generating output videos prior to determining whether or not those output videos exhibit a sufficient quality level. As such, computational resources expended to generate poor quality output videos tends to be an inefficient use of such resources.

### SUMMARY

The following Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Further, while certain disadvantages of other technologies may be discussed herein, the claimed subject matter is not intended to be limited to implementations that may solve or address any or all of the disadvantages of those other technologies. The sole purpose of this Summary is to present some concepts of the claimed subject matter in a simplified form as a prelude to the more detailed description that is presented below.

In general, given an input comprising a temporal sequence of image frames of an arbitrary scene (e.g., a “candidate set”), a “Quality Predictor” as described herein, predicts a subjective quality level of an output video that would result from applying an image sequence processing algorithm to that candidate set. If the predicted quality level exceeds a predetermined threshold, the Quality Predictor directs the image sequence processing algorithm to process the image frames of the candidate set to produce the output video. Conversely, if the predicted quality level is not sufficiently high, the Quality Predictor does not apply the image sequence processing algorithm to the candidate set. As such, the Quality Predictor reduces computational overhead by eliminating unnecessary processing of temporal sequences of image frames by the image sequence processing algorithm in cases where that algorithm is not expected or predicted to produce acceptable results. Examples of image sequence processing algorithms operable with the Quality Predictor include, but are not limited to, video looping generation algorithms, video filters, video panorama generation algorithms, etc.

More specifically, in various implementations, a machine-learned quality model is trained on a combination of human quality scores of output videos generated by the image sequence processing algorithm from each of a large number of training sets (each set comprising a temporal sequence of image frames of some arbitrary scene) and image features extracted from the frames of the training sets. In various implementations, following model training, the Quality Predictor extracts the same image features from the frames of the candidate set. The Quality Predictor then applies the machine-learned quality model to those extracted features to estimate the predicted quality level (also referred to herein as a “quality score”) prior to actually processing the image frames of the candidate set using the image sequence processing algorithm.

For example, in various implementations, the Quality Predictor begins operation by receiving a machine-learned predictive quality model. As described herein this quality model may be automatically generated from a combination of features extracted from image frames of each of a plurality of training sets and corresponding human subjective quality ratings. Each of these training sets comprises a temporal sequence of image frames of an arbitrary scene. Further, each human subjective quality rating defines a subjective quality of an output video generated by an image sequence processing algorithm from the corresponding training set. Given the trained quality model, in various implementations, the Quality Predictor then receives a candidate set comprising a temporal sequence of image frames of an arbitrary scene. The Quality Predictor then applies the quality model to features extracted from image frames of the candidate set to generate a quality score. This quality score defines a predicted subjective quality of an output video that can be generated by the image sequence processing algorithm from the candidate set. Finally, if the predicted quality score exceeds a predetermined threshold, the Quality Predictor automatically applies the image sequence processing algorithm to the candidate set to generate the corresponding output video.

The Quality Predictor described herein reduces computational overhead by applying a machine-learned quality model to predict the output quality of an image sequence processing algorithm without actually having to run that image sequence processing algorithm to process image frames of a candidate set. Candidate sets with sufficiently high quality scores are then processed by the image sequence processing algorithm to produce an output video. In addition to the benefits described above, other advantages of the Quality Predictor will become apparent from the detailed description that follows hereinafter.

### BRIEF DESCRIPTION OF THE DRAWINGS

The specific features, aspects, and advantages of the claimed subject matter will become better understood with regard to the following description, appended claims, and accompanying drawings where:

FIG. 1 provides an exemplary architectural flow diagram that illustrates program modules for effecting various implementations for training a quality model of a “Quality Predictor,” as described herein.

FIG. 2 provides an exemplary architectural flow diagram that illustrates program modules for effecting various implementations for applying the quality model of the Quality Predictor, as described herein.

FIG. 3 illustrates a general system flow diagram that illustrates exemplary techniques for effecting various implementations of the Quality Predictor, as described herein.

FIG. 4 illustrates a general system flow diagram that illustrates exemplary techniques for effecting various implementations of the Quality Predictor, as described herein.

FIG. 5 illustrates a general system flow diagram that illustrates exemplary techniques for effecting various implementations of the Quality Predictor, as described herein.

FIG. 6 is a general system diagram depicting a simplified general-purpose computing device having simplified computing and I/O capabilities for use in effecting various implementations of the Quality Predictor, as described herein.

### DETAILED DESCRIPTION

In the following description of various implementations of a “Quality Predictor”, reference is made to the accompanying drawings, which form a part hereof, and in which is shown by way of illustration specific implementations in which the Quality Predictor may be practiced. Other implementations may be utilized and structural changes may be made without departing from the scope thereof.

Specific terminology will be resorted to in describing the various implementations described herein, and that it is not intended for these implementations to be limited to the specific terms so chosen. Furthermore, it is to be understood that each specific term includes all its technical equivalents that operate in a broadly similar manner to achieve a similar purpose. Reference herein to “one implementation,” or “another implementation,” or an “exemplary implementation,” or an “alternate implementation” or similar phrases, means that a particular feature, a particular structure, or particular characteristics described in connection with the implementation can be included in at least one implementation of the Quality Predictor. Further, the appearance of such phrases throughout the specification are not necessarily all referring to the same implementation, and separate or alternative implementations are not mutually exclusive of other implementations. The order described or illustrated herein for any process flows representing one or more implementations of the Quality Predictor does not inherently indicate any requirement for the processes to be implemented in the order described or illustrated, and any such order described or illustrated herein for any process flows do not imply any limitations of the Quality Predictor.

As utilized herein, the terms “component,” “system,” “client” and the like are intended to refer to a computer-related entity, either hardware, software (e.g., in execution), firmware, or a combination thereof. For example, a component can be a process running on a processor, an object, an executable, a program, a function, a library, a subroutine, a computer, or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, to the extent that the terms “includes,” “including,” “has,” “contains,” variants thereof, and other similar words are used in either this detailed description or the claims, these terms are intended to be inclusive in a manner similar to the term “comprising” as an open transition word without precluding any additional or other elements.

1.0 Introduction:

In general, the following discussion refers to temporal sequences of images of a scene. Each of these temporal sequence of images is defined herein as any sequence of images of a scene captured over some period of time. As such, these temporal sequences of images include, but are not limited to, videos, burst sets from still cameras, time lapse sequences, or any other temporal sequence of images. However, for purposes of discussion, term “video sequence” will often be used to refer to any kind of temporal sequence of images considered or processed by the Quality Predictor. Further, temporal sequences of images of a scene used to train a predictive quality model of the Quality Predictor are referred to herein as “training sets.” Similarly, temporal sequences of images of a scene that are considered by the Quality Predictor subsequent to model training are referred to herein as “candidate sets.”

1.1 System Overview:

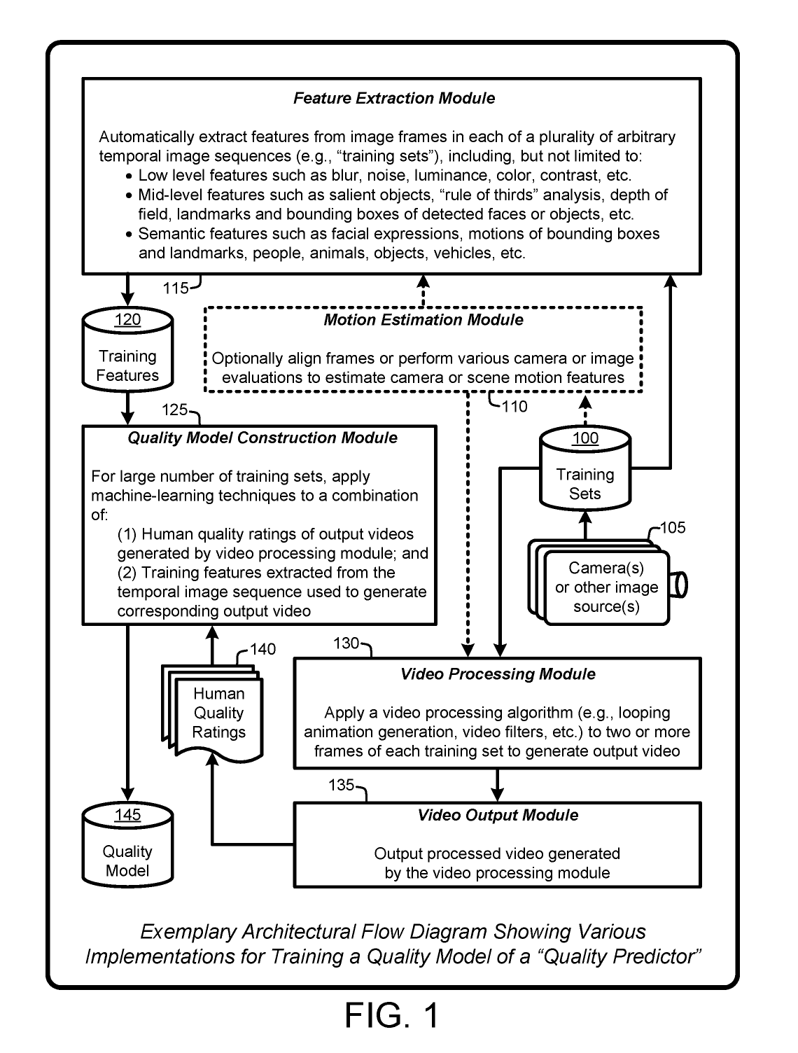

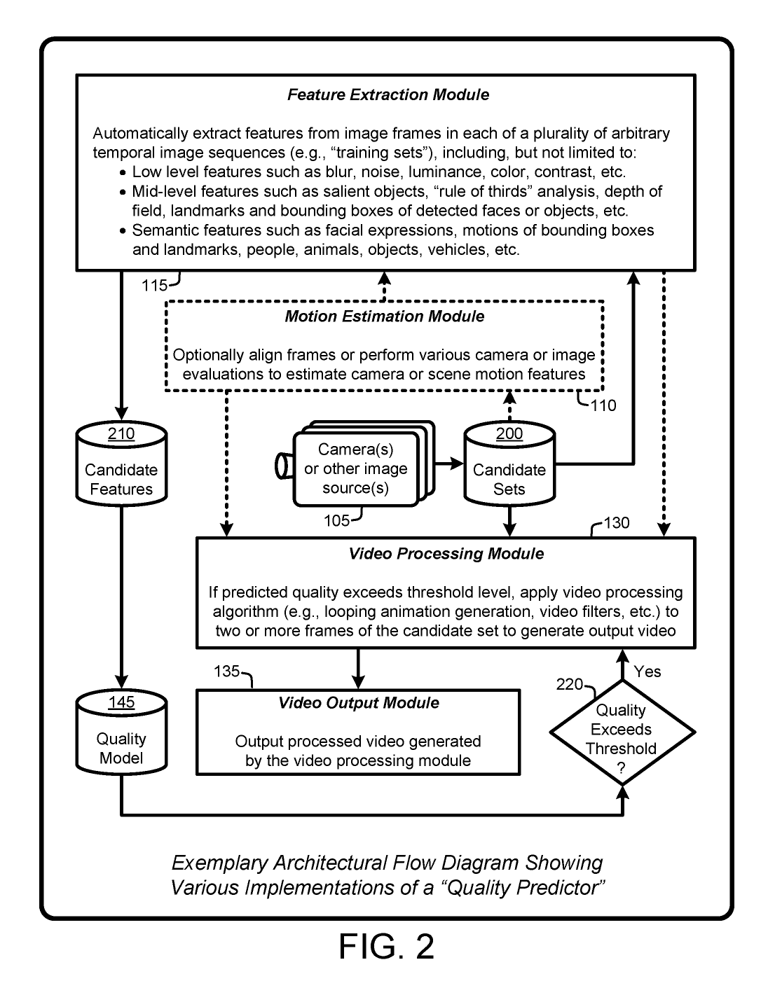

As mentioned above, the Quality Predictor reduces computational overhead by applying a machine-learned quality model to predict the output quality of an image sequence processing algorithm without actually having to run that image sequence processing algorithm to process image frames of a candidate set. Candidate sets with sufficiently high quality scores are then processed by the image sequence processing algorithm to produce an output video. Advantageously, the quality model provided by the Quality Predictor is capable of predicting this quality level in near real-time for arbitrary candidate sets. As such, while the Quality Predictor is operable on any desired computing platform, use of the Quality Predictor is particularly useful for applications where computational resources and/or battery life is a concern. The processes summarized above are illustrated by the general system diagrams of FIG. 1 and FIG. 2. In general, FIG. 1 illustrates training of the quality model from multiple sets of training image sequences, while FIG. 2 illustrates use of the quality model to predict quality that would result from applying the image sequence processing algorithm to a particular candidate set.

In particular, the system diagram of FIG. 1 illustrates the interrelationships between program modules for effecting various implementations for training the quality model of the Quality Predictor, as described herein. Furthermore, while the system diagram of FIG. 1 illustrates a high-level view of various implementations of the Quality Predictor, FIG. 1 is not intended to provide an exhaustive or complete illustration of every possible implementation of the Quality Predictor as described throughout this document.

In addition, any boxes and interconnections between boxes that may be represented by broken or dashed lines in FIG. 1 represent alternate implementations of the Quality Predictor described herein, and that any or all of these alternate implementations, as described below, may be used in combination with other alternate implementations that are described throughout this document.

As illustrated by FIG. 1, in various implementations, the processes enabled by the Quality Predictor for training the quality model begin operation by receiving or capturing a large number of training sets 100 via one or more cameras 105 or other image sources. As mentioned, each of these training sets comprises a temporal sequence of images of an arbitrary scene.

In various implementations, these training sets 100 are provided to a feature extraction module 115. The Feature Extraction Module 115 is separately applied to each of the training sets 100 to automatically extract a plurality of features from the images in each training set. In other words, the Feature Extraction Module 115 applies various image processing techniques to automatically generate a separate set of extracted training features 120 for each of the training sets 100. Examples of these features include, but are not limited to, low level features such as blur, noise, luminance, color, contrast, etc., mid-level features such as salient objects, “rule of thirds” analysis, depth of field, landmarks and bounding boxes of detected faces or objects, etc., and high-level or semantic features such as facial expressions, motions of bounding boxes and landmarks, people, animals, objects, vehicles, etc. Image feature extraction techniques are known to those skilled in the art and will not be described in detail herein.

Depending upon the particular image sequence processing algorithm being applied, camera motion may have a direct impact on the quality of any output of the image sequence processing algorithm, especially in the case of video looping generation algorithms. Consequently, in various implementations, depending upon the particular image sequence processing algorithm being used by the Quality Predictor, camera motion and/or motion of objects within image frames of the scene, may be one of the features applied in training the model. As such, in various implementations, an optional Motion Estimation Module 110 is applied to the training sets 100 to measure or otherwise estimate camera motion of any camera used to capture the image frames of those training sets and/or motions of one or more objects within those frames.

The Motion Estimation Module 110 applies any of a variety of techniques to estimate camera and/or object motions. For example, in various implementations, the Motion Estimation Module 110 aligns images in a particular training set and then estimates camera motion based on those alignments. In other implementations, the Motion Estimation Module 110 estimates camera motion by considering gyroscope or accelerometer values associated with camera (e.g., sensors in a phone having an integral camera). Other motion estimation techniques that may be performed by the Motion Estimation Module 110 include, but are not limited to, block-matching based algorithms, phase correlation and frequency domain methods, pixel recursive algorithms, optical flow modeling, motion blur based techniques, etc.

Further, in many cases, motion estimation of cameras and/or objects within the scene may provide useful information that can be reused by the image sequence processing algorithm. For example, in various looping animation and panorama generation algorithms, video stabilization/motion estimation is performed prior to loop or panorama generation. As such, depending upon the particular image sequence processing algorithm being applied by the Quality Predictor, in various implementations, the motion estimates generated by the Motion Estimation Module 110 are provided for use by the Video Processing Module 130, so as to further reduce computational overhead by the Video Processing Module. Similarly, other features generated by the Feature Extraction Module 115 may also be provided to the Video Processing Module 130 depending upon whether those features may be useful for generation of output videos by the Video Processing Module. For purposes of image clarity, the optional connection between the Feature Extraction Module 115 and the Video Processing Module 130 for passing of image features is not illustrated in FIG. 1.

In addition, the training sets 100 are provided to the Video Processing Module 130. In general, the Video Processing Module 130 applies an image sequence processing algorithm (e.g., looping animation generation, video filters, video panorama generation algorithms, video summarization or video “thumbnail” generation (where a subset of frames are selected as being representative of the longer video), video retargeting or resizing (which generally operates to change the aspect ratio and/or resolution of the video, etc.) to two or more frames of each training set 100 to generate corresponding output videos that are output via a Video Output Module 135. Human quality ratings 140 (e.g., a score of 1 to 5, with 5 corresponding to a high quality output video and 1 corresponding to a poor quality output video) are then assigned to each of the output videos generated from the training sets 100.

The training features 120, which may include camera and/or object motion features, are then provided to a Quality Model Construction Module 125 along with the corresponding human quality ratings 140. The Quality Model Construction Module 125 then generates a quality model 145 by applying various machine-learning techniques to a combination of: (1) human quality ratings of output videos generated by the Video Processing Module 130, and (2) training features 120 extracted from the training sets used to generate corresponding output videos.

Given the quality model 145, the Quality Predictor is then capable of predicting quality scores for arbitrary temporal sequence of images of arbitrary scenes. For example, the system diagram of FIG. 2 illustrates the interrelationships between program modules for instantiating various implementations for applying the quality model of the Quality Predictor to candidate sets, as described herein. Furthermore, while the system diagram of FIG. 2 illustrates a high-level view of various implementations of the Quality Predictor, FIG. 2 is not intended to provide an exhaustive or complete illustration of every possible implementation of the Quality Predictor as described throughout this document.

In addition, any boxes and interconnections between boxes that may be represented by broken or dashed lines in FIG. 2 represent alternate implementations of the Quality Predictor described herein, and that any or all of these alternate implementations, as described below, may be used in combination with other alternate implementations that are described throughout this document. Furthermore, any of the components of FIG. 2 that show the same element numbers as FIG. 1 are intended to show reuse of the corresponding elements of FIG. 1 within the system diagram of FIG. 2.

More specifically, as illustrated by FIG. 2, the cameras or other image sources 105 (which may be different sources than those used to provide the training sets 100) are used to provide a candidate set 200 comprising a temporal sequence of images of an arbitrary scene. As with the training sets 100 illustrated in FIG. 1, either or both the Feature Extraction Module 115 and the Motion Estimation Module 110 are applied as illustrated by FIG. 2 to extract a plurality of candidate features 210, which may include optional camera and/or object motions, from the candidate set 200.

The quality model 145 is then applied to evaluate the candidate features 200 to estimate or predict a quality score for an output video that could be generated from the corresponding candidate set 200 by the Video Processing Module 130. In the event that the quality score exceeds 220 a predetermined or adjustable threshold, the Video Processing Module 130 is directed to process the candidate set 150 to generate an output video. Further, in the event that the quality score exceeds 220 the predetermined or adjustable threshold, and depending upon the particular image sequence processing algorithm being applied by the Quality Predictor, one or more features generated by the Feature Extraction Module 115 and/or one or more of the optional motion estimates generated by the Motion Estimation Module 110 may be provided for use by the Video Processing Module 130, so as to further reduce computational overhead of the Video Processing Module. The resulting output video generated by the Video Processing Module 130 is then provided for user interaction or storage for later use via the Video Output Module 135.

2.0 Operational Details of the Quality Predictor:

The above-described program modules and/or devices are employed for instantiating various implementations of the Quality Predictor. As summarized above, the Quality Predictor reduces computational overhead by applying a machine-learned quality model to predict the output quality of an image sequence processing algorithm without actually having to run that image sequence processing algorithm to process image frames of a candidate set. Candidate sets with sufficiently high quality scores are then processed by the image sequence processing algorithm to produce an output video. The following sections provide a detailed discussion of the operation of various implementations of the Quality Predictor, and of exemplary methods and techniques for implementing the features and program modules described in Section 1 with respect to FIG. 1 and FIG. 2. In particular, the following sections provides examples and operational details of various implementations of the Quality Predictor, including:

An operational overview of the Quality Predictor;

Feature extraction;

Human quality ratings;

Quality model training;

Exemplary image sequence processing algorithms; and

Predicting quality of image sequence processing algorithm outputs.

2.1 Operational Overview:

As mentioned above, the Quality Predictor applies a machine-learned predictive quality model to predict or estimate a subjective quality level of an output video that would result from applying an image sequence processing algorithm to candidate sets comprising temporal sequences of images of a scene. Examples of such image sequence processing algorithms include, but are not limited to, video looping generation algorithms, video filters, video panorama generation algorithms, video summarization or video “thumbnail” generation (where a subset of frames are selected as being representative of the longer video), video retargeting or resizing (which generally operates to change the aspect ratio and/or resolution of the video, etc. If the predicted quality level exceeds a predetermined threshold, the Quality Predictor directs the image sequence processing algorithm to process the image frames of the candidate set to produce the output video. Conversely, if the predicted quality level is not sufficiently high, the Quality Predictor does not apply the image sequence processing algorithm to the candidate set. As such, the Quality Predictor reduces computational overhead by eliminating unnecessary processing of temporal sequences of image frames by the image sequence processing algorithm in cases where that algorithm is not expected or predicted to produce acceptable results.

2.2 Feature Extraction:

In general, the features that are extracted by the Quality Predictor from frames of each temporal sequence of image frames depend on the particular image sequence processing algorithm being used. For example, features useful for predicting output quality of a video looping algorithm may differ from features useful for predicting output quality of a video filtering algorithm, which may both differ from features useful for predicting output quality of a video panorama generation algorithm. However, there may be common features that are useful for some or all of the image sequence processing algorithms. Further, some features are extracted directly from image frames, while other features may be determined by looking at differences between frames in the temporal sequence, e.g., low-level measures of camera and/or content motion between frames.

As such, the feature extraction processing operations of the Quality Predictor extract features relevant to whatever image sequence processing algorithm is being used. Further, in various implementations, the Quality Predictor provides access to multiple image sequence processing algorithms. Consequently, different sets of features may be defined and associated with all of these different image sequence processing algorithms. These different sets of features may be extracted at the same time (or at different times) and provided for use in training separate quality models (discussed in further detail in Section 2.4 of this document) for each of the different image sequence processing algorithms. As discussed, this model training is based on whatever features are appropriate for the particular model in combination with human quality ratings or scores of outputs of the corresponding image sequence processing algorithm. In other words, the Quality Predictor extracts some predefined set of features relevant to the particular image sequence processing algorithm and then applies those features in combination with human ratings of the quality of corresponding output videos to train the quality model.

For example, assuming that the image sequence processing algorithm is a video looping generation algorithm, the features extracted for model training (and subsequent quality scoring of candidate sets), may include, but are not limited to, features such as mean, max and median of images, blur, spatial pyramid blurriness features (e.g., global and spatially local blur estimation values), noise, luminance, luminance gradient histograms, brightness, brightness histograms, color, hue, saturation, contrast, salient objects, “rule of thirds” analysis, depth of field, number of faces, face size, ratio and location, face landmark features, such as eyes open or closed features, mouth open or closed, etc., facial expressions, image content motions, camera motions, composition features, etc. Multiple techniques for extracting such image features from image sequences are known to those skilled in the art and will not be described in detail herein.

The features (also referred to herein as descriptors) are extracted from the entirety of each individual temporal sequence of image frames (whether it is a training set or a candidate set) prior to processing that temporal sequence of image frames with the image sequence processing algorithm. In other words, feature extraction is performed on the input frames and not on the frames of the output video generated by the image sequence processing algorithm.

In various implementations, the features are grouped into low, medium and high (or semantic) level categories. The specific features associated with any particular image sequence processing algorithm can change over time. For example, new or different features may prove to be more relevant to accurate determination of quality scores, image characteristics may change (e.g., camera has changes or new image capture capabilities), a particular image sequence processing algorithm may change, etc. Regardless of the reason for changing features, quality models may be updated at any time by simply defining some new set of features, extracting those features from training sets, and then retraining one or more corresponding quality models on the combination of features and corresponding human quality ratings of corresponding output videos. In general, any features derived from the sequence of images are relevant to model training. However, some of the features may be more relevant than others, depending on factors such as, for example, the particular image sequence processing algorithm being used, the particular machine-learning techniques being applied to learn or otherwise train the quality model, etc.

Further, in various implementations, even assuming the same image sequence processing algorithm, different feature sets may be extracted for training based on different types of image sequences. For example, a highly dynamic image sequence (e.g., sports sequence) may use a different feature set to train the quality model than a relatively static image sequence (e.g., child blowing out candles on a birthday cake). In such implementations, the Quality Predictor adds an initial evaluation step that categorizes the type of image sequence being considered. Predefined features appropriate to that category are then extracted (both for model training and quality predictions for candidate sets of the same category).

2.3 Human Quality Ratings:

In various implementations, multiple human users provide subjective quality ratings or scores for the output videos produced by applying the image sequence processing algorithm to each of a large number of training sets. More specifically, human review of each individual output of the image sequence processing algorithm is performed to score the resulting output video of that algorithm. Further, multiple different humans may review the same output videos. As such, ratings from different humans that differ for the same output video may be combined, averaged, pruned with respect to high or low scores or ratings, etc., to produce a single composite rating for each output video generated from each training set. Further, in various implementations, even assuming the same image sequence processing algorithm, ratings by different demographic groups (e.g., gender, age, profession, etc.) for the same output videos may be applied to train separate quality models that are tailored to the preferences of those groups. Users may then select a particular quality trained based on a particular demographic group.

In addition, in various implementations, the human rating or score for one or more output videos may be annotated or tagged (e.g., annotation vectors) by the person scoring or rating that output video to include information relating to the features considered by that person in selecting that best images. As such, depending on how many humans have reviewed any particular output video generated from training sets, and the ratings or scores made by those humans, any particular output video may include additional features (e.g., annotation vectors or the like) that may be considered along with any other features for model training purposes.

2.4 Quality Model Training:

In various implementations, training of the machine-learned quality model for predicting the quality of an output video from the image sequence processing algorithm is achieved by applying various machine-learning techniques to learn a predication function, ƒ. In various implementations, the prediction function comprising the quality model is learned from a combination of image features (see Section 2.2 of this document) and human quality ratings of corresponding output videos (see Section 2.3 of this document). Any desired model generation techniques may be applied to the combination of features and human ratings for generation of the quality model. Examples of such techniques include, but are not limited to nonlinear regression engines, classifiers, support vector machines, random forests, neural networks, etc.

Regardless of the training techniques used, model training is performed using features sets that are specific to whatever image sequence processing algorithm is being used. As such, multiple different quality models may be trained, with each model corresponding to a particular image sequence processing algorithm and/or to a particular category of image sequence (e.g., a highly dynamic image sequence, a relatively static image sequence, etc.). Users may then select whichever one or more of the image sequence processing algorithms they wish to apply to a candidate set. In response, the Quality Predictor will automatically apply the corresponding quality model to features extracted from that candidate set to predict the quality level of the output of the selected image sequence processing algorithm.

Advantageously, because the training considers image sequence features in combination with human quality scores or ratings of corresponding output videos, the resulting quality models may closely emulate human subjective ratings of the output video that can be produced by the image sequence processing algorithm before that algorithm is ever applied to the candidate set. As such, models may be trained based on quality ratings of particular demographic groups of people (e.g., gender, age, profession, etc.).

2.5 Exemplary Image Sequence Processing Algorithms:

Examples of image sequence processing algorithms operable with the Quality Predictor include, but are not limited to, video looping generation algorithms, video filters, video panorama generation algorithms, video summarization or video “thumbnail” generation (where a subset of frames are selected as being representative of the longer video), video retargeting or resizing (which generally operates to change the aspect ratio and/or resolution of the video, etc. Further, in the case of video looping algorithms some of these algorithms may operate to construct video loops from automatically detected independent regions of image frames of the candidate set, while other video looping generation algorithms may operate to construct video loops from entire frames (which may be cropped and/or aligned) of image frames of the candidate set.

2.6 Predicting Quality of Algorithm Outputs Prior to Execution:

In general, the quality model of the Quality Predictor predicts the quality of image sequence processing algorithm outputs for arbitrary candidate sets prior to actually processing those candidate sets. As a result, the Quality Predictor reduces computational overhead by eliminating unnecessary processing of temporal sequences of image frames (e.g., the candidate set) by the image sequence processing algorithm in cases where that algorithm is not expected or predicted to produce acceptable results.

Further, in various implementations, the Quality Predictor includes an initial evaluation step that categorizes the type of image sequence being considered. As such, given trained models for each category type (e.g., highly dynamic scene, relatively static scene, indoor scenes, outdoor scenes, etc.) the Quality Predictor determines the appropriate category via an initial analysis of the frames of the candidate set and then selects the corresponding quality model. Predefined features appropriate to that category are then extracted from the candidate set. The quality model then estimates or predicts a quality level or score for that candidate set based solely on the features extracted from the candidate set.

For example, assuming that the image sequence processing algorithm is a video looping generation algorithm, the Quality Predictor evaluates features extracted from the image frames of the candidate set to predict a likely human subjective quality level of a looping animation that could be constructed from those frames. If the predicted quality level exceeds an optionally adjustable threshold level, the Quality Predictor passes the candidate set to the video looping generation algorithm to generate a corresponding looping animation. The video looping generation algorithm then performs various alignment and stitching operations to construct a looping animation from two or more frames of the candidate set.

Further, various elements of the frames, e.g., faces or other objects, may be isolated and stabilized in the animation generated by the video looping generation algorithm. For example, a face detected in one or more image frames of the candidate set may be isolated (e.g., extracted from one or more of the frames) and stabilized in a fixed position in the resulting animation. In this animation, the stabilized face (or other object) maintains a fixed position, while dynamic elements from the other image frames appear to be animated by quickly cycling those frames. Any of a variety of image stitching and looping techniques may be applied by any image sequence processing algorithm used by the Quality Predictor for construction of looping animated images.

In addition, in the case of video looping algorithms, such algorithms sometimes generate a “loop” that appears to be a still image where nothing is moving (or is moving nearly imperceptibly), even though it consists of multiple frames. As such, in various implementations, the Quality Predictor may train an additional model to predict whether the output video produced by the video looping algorithm is likely to appear as a still image. A simple example is a regression model trained to predict whether the output would be still or not. Alternately, the quality model can be trained to predict both a quality rating or score and whether or not the resulting output video is likely to appear to be a still image. In either case, training is achieved by receiving a binary rating (e.g., 0 or 1) to indicate whether the output video was still or not from the humans that are also rating the quality of each of the output videos generated from the training sets.

3.0 Operational Summary of the Quality Predictor:

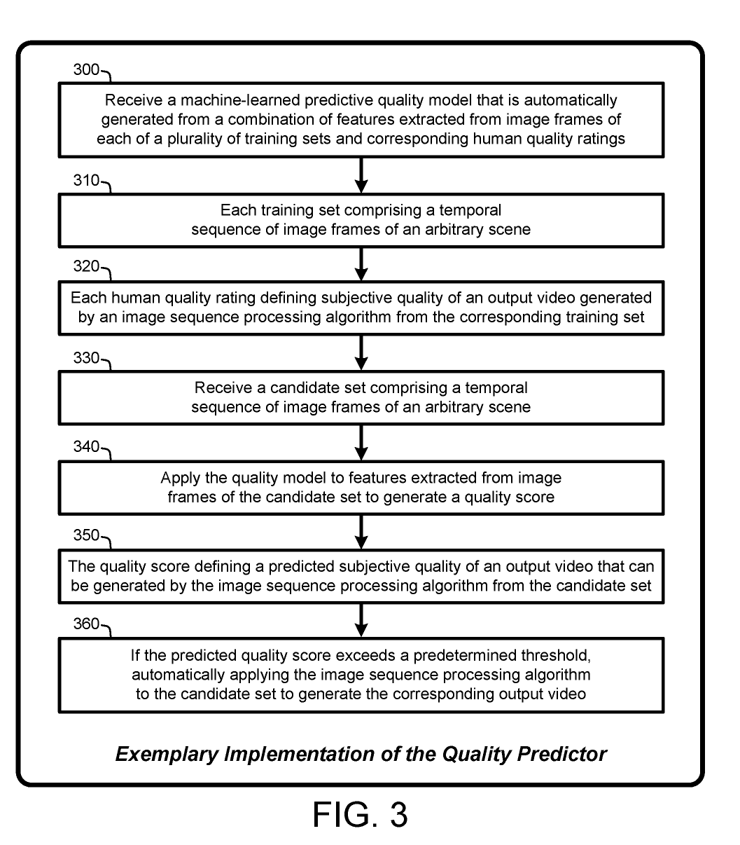

The processes described above with respect to FIG. 1 and FIG. 2, and in further view of the detailed description provided above in Sections 1 and 2, are illustrated by the general operational flow diagrams of FIG. 3 through FIG. 5. In particular, FIG. 3 through FIG. 5 provide exemplary operational flow diagrams that summarizes the operation of some of the various implementations of the Quality Predictor. FIG. 3 through FIG. 5 are not intended to provide an exhaustive representation of all of the various implementations of the Quality Predictor described herein, and the implementations represented in these figures are provided only for purposes of explanation.

Further, any boxes and interconnections between boxes that may be represented by broken or dashed lines in FIG. 3 through FIG. 5 represent optional or alternate implementations of the Quality Predictor described herein, and that any or all of these optional or alternate implementations, as described below, may be used in combination with other alternate implementations that are described throughout this document.

In general, as illustrated by FIG. 3, in various implementations, the Quality Predictor begins operation by receiving 300 a machine-learned predictive quality model, the quality model automatically generated from a combination of features extracted from image frames of each of a plurality of training sets and corresponding human quality ratings. In various implementations, each set comprises 310 a temporal sequence of image frames of an arbitrary scene. Further, in various implementations, each human quality rating defines 320 a subjective quality of an output video generated by an image sequence processing algorithm from the corresponding training set. Given the predictive quality model, the Quality Predictor then receives 330 a candidate set comprising a temporal sequence of image frames of an arbitrary scene. Next, in various implementations, the Quality Predictor applies 340 the quality model to features extracted from image frames of the candidate set to generate a quality score. This quality score defines 350 a predicted subjective quality of an output video that can be generated by the image sequence processing algorithm from the candidate set. Finally, in various implementations, if the predicted quality score exceeds 360 a predetermined threshold, the Quality Predictor automatically applies the image sequence processing algorithm to the candidate set to generate the corresponding output video.

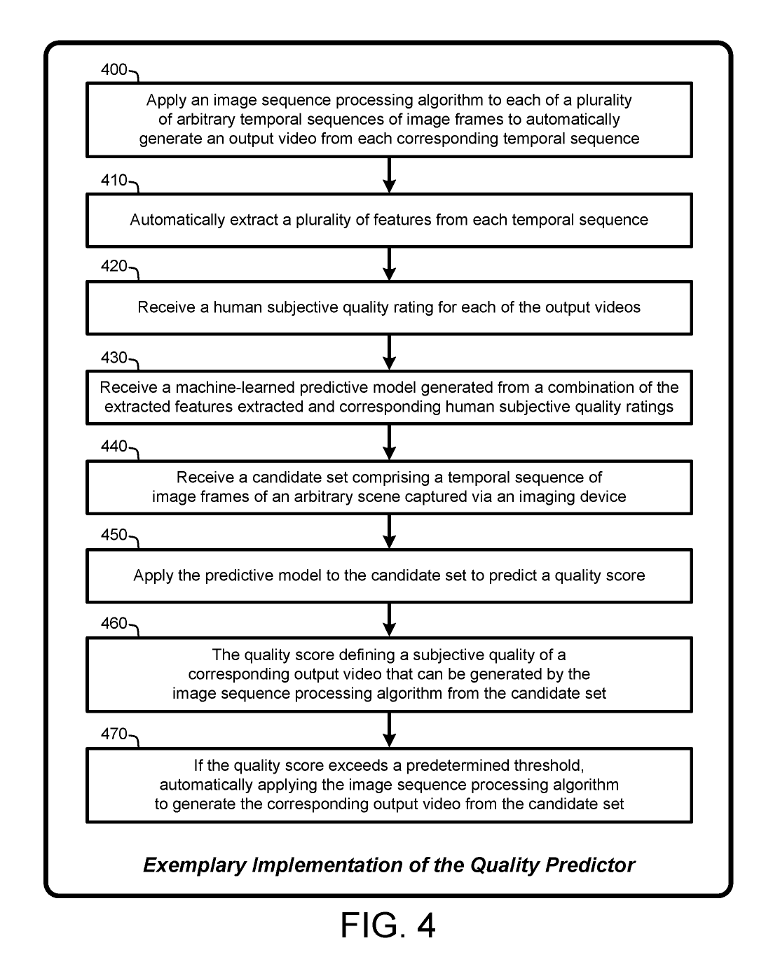

Similarly, as illustrated by FIG. 4, in various implementations, the Quality Predictor begins operation by applying 400 an image sequence processing algorithm to each of a plurality of arbitrary temporal sequences of image frames to automatically generate an output video from each corresponding temporal sequence. In addition, in various implementations, the Quality Predictor automatically extracts 410 a plurality of features from each temporal sequence. Further, the Quality Predictor receives 420 a human subjective quality rating for each of the output videos. In addition, in various implementations, the Quality Predictor receives 430 a machine-learned predictive model generated from a combination of the features extracted from each temporal sequence and the human subjective quality ratings of the corresponding output videos. Next, in various implementations, the quality predictor receives 440 a candidate set comprising a temporal sequence of image frames of an arbitrary scene captured via an imaging device. In various implementations, the Quality Predictor then applies 450 the predictive model to the candidate set to predict a quality score. In general, the quality score defines 460 a subjective quality of a corresponding output video that can be generated by the image sequence processing algorithm from the candidate set. Finally, in various implementations, if the quality score exceeds 470 a predetermined threshold, automatically applying the image sequence processing algorithm to generate the corresponding output video from the candidate set.

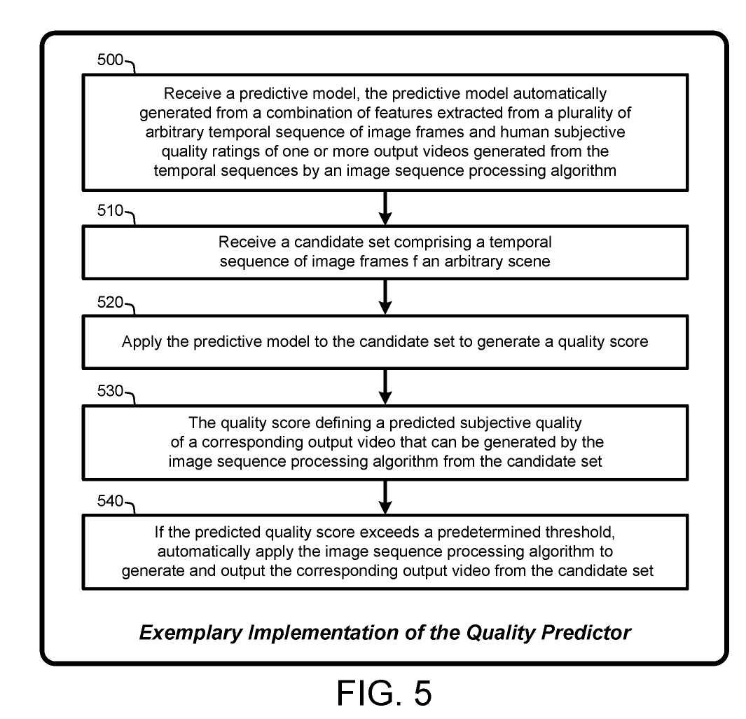

Similarly, as illustrated by FIG. 5, in various implementations, the Quality Predictor begins operation by receiving 500 a predictive model, the predictive model automatically generated from a combination of features extracted from a plurality of arbitrary temporal sequence of image frames and human subjective quality ratings of one or more output videos generated from the temporal sequences by an image sequence processing algorithm. In addition, in various implementations, the Quality Predictor receives 510 a candidate set comprising a temporal sequence of image frames of an arbitrary scene. Then, in various implementations, the Quality Predictor applies 520 the predictive model to the candidate set to generate a quality score. In general, this quality score defines 530 a predicted subjective quality of a corresponding output video that can be generated by the image sequence processing algorithm from the candidate set. Finally, in various implementations, if the predicted quality score exceeds 540 a predetermined threshold, the Quality Predictor automatically applies the image sequence processing algorithm to generate and output the corresponding output video from the candidate set.

4.0 Exemplary Implementations of the Quality Predictor:

The following paragraphs summarize various examples of implementations that may be claimed in the present document. The implementations summarized below are not intended to limit the subject matter that may be claimed in view of the detailed description of the Quality Predictor. Further, any or all of the implementations summarized below may be claimed in any desired combination with some or all of the implementations described throughout the detailed description and any implementations illustrated in one or more of the figures, and any other implementations and examples described below. The following implementations and examples are intended to be understood in view of the detailed description and figures described throughout this document.

In various implementations, the Quality Predictor is implemented by means, processes or techniques for reducing computational overhead by applying a machine-learned quality model to predict the output quality of an image sequence processing algorithm without actually having to run that image sequence processing algorithm to process image frames of a candidate set. Candidate sets with sufficiently high quality scores are then processed by the image sequence processing algorithm to produce an output video.

As a first example, in various implementations, a computer-implemented process for effecting the Quality Predictor is provided via means, processes or techniques for receiving a machine-learned predictive quality model, the quality model automatically generated from a combination of features extracted from image frames of each of a plurality of training sets and corresponding human quality ratings. Further, each training set comprises a temporal sequence of image frames of an arbitrary scene. In addition, each human quality rating defines a subjective quality of an output video generated by an image sequence processing algorithm from the corresponding training set. The Quality Predictor then receives a candidate set comprising a temporal sequence of image frames of an arbitrary scene. Next, the Quality Predictor applies the quality model to features extracted from image frames of the candidate set to generate a quality score. This quality score defines a predicted subjective quality of an output video that can be generated by the image sequence processing algorithm from the candidate set. Finally, in various implementations, if the predicted quality score exceeds a predetermined threshold, the Quality Predictor automatically applies the image sequence processing algorithm to the candidate set to generate the corresponding output video.

As a second example, in various implementations, the first example is further modified via means, processes or techniques wherein the image sequence processing algorithm further comprises an algorithm for generating a looping animation from two or more frames.

As a third example, in various implementations, the first example is further modified via means, processes or techniques wherein the image sequence processing algorithm further comprises a video filter for generating a filtered version of two or more image frames.

As a fourth example, in various implementations, the first example is further modified via means, processes or techniques wherein the image sequence processing algorithm further comprises a video panorama generation algorithm for generating a video panorama from multiple image frames.

As a fifth example, in various implementations, any of the first example, the second example, the third example and the fourth example are further modified via means, processes or techniques further comprising a plurality of selectable quality models, each quality model trained, in part, on human quality ratings received from a particular demographic group.

As a sixth example, in various implementations, any of the first example, the second example, the third example, the fourth example and the fifth example are further modified via means, processes or techniques further comprising determining an image sequence type of the candidate set, and applying a quality model trained, in part, on similar types of image sequences to generate the quality score.

As a seventh example, in various implementations, any of the first example, the second example, the third example, the fourth example, the fifth example and the sixth example are further modified via means, processes or techniques further comprising a plurality of different image sequence processing algorithms, a separate quality model trained for each of the different image sequence processing algorithm, and automatically selecting and applying a corresponding quality model to generate the quality score in response to a user selection of one of a particular one of the different image sequence processing algorithms.

As an eighth example, in various implementations, the seventh example is further modified via means, processes or techniques further comprising defining a different set of features to be extracted for each of the different image sequence processing algorithms.

As a ninth example, in various implementations, any of the first example, the second example, the third example, the fourth example, the fifth example, the sixth example, the seventh example and the eighth example are further modified via means, processes or techniques further comprising estimating motions for each training set and providing the estimated motions as one of the extracted features for use in training the quality model.

As a tenth example, in various implementations, the ninth example is further modified via means, processes or techniques further comprising estimating motions for the candidate set and providing the estimated motions as one of the extracted features for use by the quality model in generating the quality score.

As an eleventh example, in various implementations, a method for effecting the Quality Predictor is provided via means, processes or techniques for applying an image sequence processing algorithm to each of a plurality of arbitrary temporal sequences of image frames to automatically generate an output video from each corresponding temporal sequence. In addition, the Quality Predictor automatically extracts a plurality of features from each temporal sequence. Further, the Quality Predictor receives a human subjective quality rating for each of the output videos. The Quality Predictor then receives a machine-learned predictive model generated from a combination of the features extracted from each temporal sequence and the human subjective quality ratings of the corresponding output videos. Next, in various implementations, the Quality Predictor receives a candidate set comprising a temporal sequence of image frames of an arbitrary scene captured via an imaging device. The Quality Predictor then applies the predictive model to the candidate set to predict a quality score. This quality score defines a subjective quality of a corresponding output video that can be generated by the image sequence processing algorithm from the candidate set. Finally, if the quality score exceeds a predetermined threshold, the Quality Predictor automatically applies the image sequence processing algorithm to generate the corresponding output video from the candidate set.

As a twelfth example, in various implementations, the eleventh example is further modified via means, processes or techniques further comprising a plurality of selectable quality models, each quality model trained, in part, on human quality ratings received from a particular demographic group.

As a thirteenth example, in various implementations, any of the eleventh example and the twelfth example are further modified via means, processes or techniques further comprising determining an image sequence type of the candidate set, and applying a quality model trained, in part, on similar types of image sequences to predict the quality score.

As a fourteenth example, in various implementations, any of the eleventh example, the twelfth example and the thirteenth example are further modified via means, processes or techniques further comprising a plurality of different image sequence processing algorithms and a separate quality model trained for each of the different image sequence processing algorithm. In various implementations, the Quality Predictor then automatically selects and applies a corresponding quality model to predict the quality score in response to a user selection of one of a particular one of the different image sequence processing algorithms.

As a fifteenth example, in various implementations, the fourteenth example is further modified via means, processes or techniques further comprising defining a different set of features to be extracted for each of the different image sequence processing algorithms.

As a sixteenth example, in various implementations, any of the eleventh example, the twelfth example, the thirteenth example, the fourteenth example, and the fifteenth example are further modified via means, processes or techniques further comprising estimating motions for each training set and providing the estimated motions as one of the extracted features for use in training the quality model.

As a seventeenth example, in various implementations, the sixteenth example is further modified via means, processes or techniques further comprising estimating motions for the candidate set and providing the estimated motions as one of the extracted features for use by the quality model in generating the quality score.

As an eighteenth example, in various implementations, the Quality Predictor is effected via means, processes or techniques that begin operation by receiving a predictive model, the predictive model automatically generated from a combination of features extracted from a plurality of arbitrary temporal sequence of image frames and human subjective quality ratings of one or more output videos generated from the temporal sequences by an image sequence processing algorithm. In addition, the Quality Predictor then receives a candidate set comprising a temporal sequence of image frames of an arbitrary scene. In various implementations, the Quality Predictor then applies the predictive model to the candidate set to generate a quality score. This quality score defines a predicted subjective quality of a corresponding output video that can be generated by the image sequence processing algorithm from the candidate set. Finally, if the predicted quality score exceeds a predetermined threshold, the Quality Predictor automatically applies the image sequence processing algorithm to generate and output the corresponding output video from the candidate set.

As a nineteenth example, in various implementations, the eighteenth example is further modified via means, processes or techniques further comprising determining an image sequence type of the candidate set, and applying a quality model trained, in part, on similar types of image sequences to predict the quality score.

As a twentieth example, in various implementations, any of the eighteenth example and the nineteenth example are further modified via means, processes or techniques further comprising a plurality of different image sequence processing algorithms and a separate quality model trained for each of the different image sequence processing algorithm. In various implementations, the Quality Predictor then automatically selects and applies a corresponding quality model to predict the quality score in response to a user selection of one of a particular one of the different image sequence processing algorithms.

5.0 Exemplary Operating Environments:

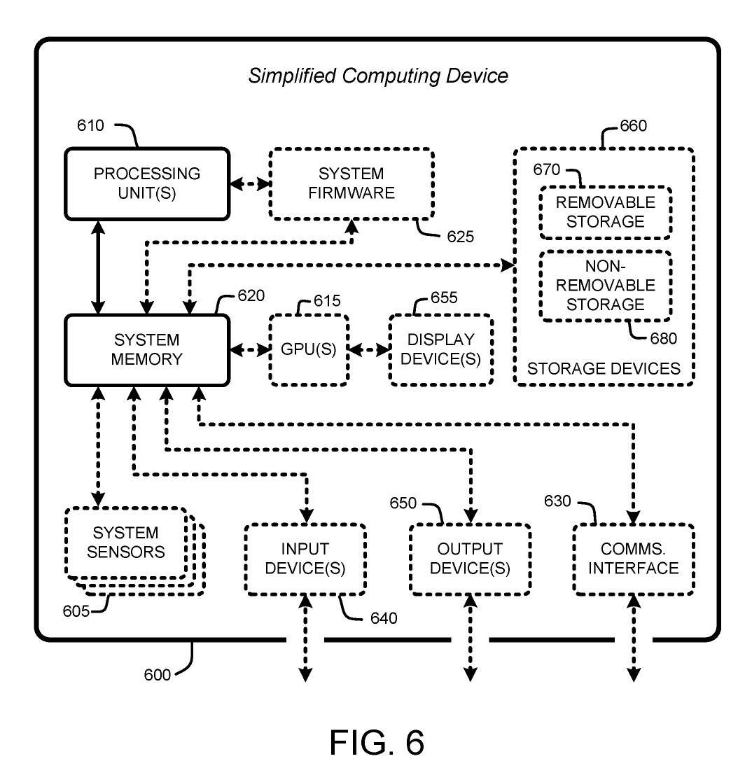

The Quality Predictor implementations described herein are operational within numerous types of general purpose or special purpose computing system environments or configurations. FIG. 6 illustrates a simplified example of a general-purpose computer system on which various implementations and elements of the Quality Predictor, as described herein, may be implemented. Any boxes that are represented by broken or dashed lines in the simplified computing device 600 shown in FIG. 6 represent alternate implementations of the simplified computing device. As described below, any or all of these alternate implementations may be used in combination with other alternate implementations that are described throughout this document.

The simplified computing device 600 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the Quality Predictor implementations described herein, the device should have a sufficient computational capability and system memory to enable basic computational operations. In particular, the computational capability of the simplified computing device 600 shown in FIG. 6 is generally illustrated by one or more processing unit(s) 610, and may also include one or more graphics processing units (GPUs) 615, either or both in communication with system memory 620. The processing unit(s) 610 of the simplified computing device 600 may be specialized microprocessors (such as a digital signal processor (DSP), a very long instruction word (VLIW) processor, a field-programmable gate array (FPGA), or other micro-controller) or can be conventional central processing units (CPUs) having one or more processing cores and that may also include one or more GPU-based cores or other specific-purpose cores in a multi-core processor.

In addition, the simplified computing device 600 may also include other components, such as, for example, a communications interface 630. The simplified computing device 600 may also include one or more conventional computer input devices 640 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 600 and with any other component or feature of the Quality Predictor, including input, output, control, feedback, and response to one or more users or other devices or systems associated with the Quality Predictor, are enabled by a variety of Natural User Interface (NUI) scenarios. The NUI techniques and scenarios enabled by the Quality Predictor include, but are not limited to, interface technologies that allow one or more users user to interact with the Quality Predictor in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other input devices 640 or system sensors 605. Such NUI implementations are also enabled by the use of various techniques including, but not limited to, information derived from system sensors 605 or other input devices 640 from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices.

Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited to, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the Quality Predictor.

However, the aforementioned exemplary NUI scenarios may be further augmented by combining the use of artificial constraints or additional signals with any combination of NUI inputs. Such artificial constraints or additional signals may be imposed or generated by input devices 640 such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the Quality Predictor.

The simplified computing device 600 may also include other optional components such as one or more conventional computer output devices 650 (e.g., display device(s) 655, audio output devices, output video devices, devices for transmitting wired or wireless data transmissions, and the like). Typical communications interfaces 630, input devices 640, output devices 650, and storage devices 660 for general-purpose computers are well known to those skilled in the art, and will not be described in detail herein.

The simplified computing device 600 shown in FIG. 6 may also include a variety of computer-readable media. Computer-readable media can be any available media that can be accessed by the computing device 600 via storage devices 660, and include both volatile and nonvolatile media that is either removable 670 and/or non-removable 680, for storage of information such as computer-readable or computer-executable instructions, data structures, program modules, or other data.

Computer-readable media includes computer storage media and communication media. Computer storage media refers to tangible computer-readable or machine-readable media or storage devices such as digital versatile disks (DVDs), Blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, program modules, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. The terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, and/or computer program products embodying some or all of the various Quality Predictor implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware 625, hardware, or any combination thereof to control a computer to implement the disclosed subject matter. The term “article of manufacture” as used herein is intended to encompass a computer program accessible from any computer-readable device, or media.

The Quality Predictor implementations described herein may be further described in the general context of computer-executable instructions, such as program modules, being executed by a computing device. Generally, program modules include routines, programs, objects, components, data structures, and the like, that perform particular tasks or implement particular abstract data types. The Quality Predictor implementations may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), and so on.

6.0 Other Implementations:

The foregoing description of the Quality Predictor has been presented for the purposes of illustration and description. It is not intended to be exhaustive or to limit the claimed subject matter to the precise form disclosed. Many modifications and variations are possible in light of the above teaching. Further, any or all of the aforementioned alternate implementations may be used in any combination desired to form additional hybrid implementations of the Quality Predictor. It is intended that the scope of the Quality Predictor be limited not by this detailed description, but rather by the claims appended hereto. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other equivalent features and acts are intended to be within the scope of the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of detailed description of the Quality Predictor described above.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known to enable such interactions.

What is claimed is:

1. A computer-implemented process, comprising applying a computer to perform process actions for:
receiving a machine-learned predictive quality model, the quality model automatically generated from a combination of features extracted from image frames of each of a plurality of training sets and corresponding human quality ratings;
each training set comprising a temporal sequence of image frames of an arbitrary scene;
each human quality rating defining a subjective quality of an output video generated by an image sequence processing algorithm from the corresponding training set;
receiving a candidate set comprising a temporal sequence of image frames of an arbitrary scene;
applying the quality model to features extracted from image frames of the candidate set to generate a quality score;
the quality score defining a predicted subjective quality of an output video that can be generated by the image sequence processing algorithm from the candidate set; and
if the predicted quality score exceeds a predetermined threshold, automatically applying the image sequence processing algorithm to the candidate set to generate the corresponding output video.

2. The computer-implemented process of claim 1, the image sequence processing algorithm comprising an algorithm for generating a looping animation from two or more frames.

3. The computer-implemented process of claim 1, the image sequence processing algorithm comprising a video filter for generating a filtered version of two or more image frames.

4. The computer-implemented process of claim 1, the image sequence processing algorithm comprising a video panorama generation algorithm for generating a video panorama from multiple image frames.

5. The computer-implemented process of claim 1 further comprising a plurality of selectable quality models, each quality model trained, in part, on human quality ratings received from a particular demographic group.

6. The computer-implemented process of claim 1 further comprising:
determining an image sequence type of the candidate set; and
applying a quality model trained, in part, on similar types of image sequences to generate the quality score.

7. The computer-implemented process of claim 1 further comprising:
a plurality of different image sequence processing algorithms;
a separate quality model trained for each of the different image sequence processing algorithm; and
automatically selecting and applying a corresponding quality model to generate the quality score in response to a user selection of one of a particular one of the different image sequence processing algorithms.

8. The computer-implemented process of claim 7 further comprising defining a different set of features to be extracted for each of the different image sequence processing algorithms.

9. The computer-implemented process of claim 1 further comprising estimating motions for each training set and providing the estimated motions as one of the extracted features for use in training the quality model.

10. The computer-implemented process of claim 9 further comprising estimating motions for the candidate set and providing the estimated motions as one of the extracted features for use by the quality model in generating the quality score.

11. A method, comprising:
applying an image sequence processing algorithm to each of a plurality of arbitrary temporal sequences of image frames to automatically generate an output video from each corresponding temporal sequence;
automatically extracting a plurality of features from each temporal sequence;
receiving a human subjective quality rating for each of the output videos;
receiving a machine-learned predictive model generated from a combination of the features extracted from each temporal sequence and the human subjective quality ratings of the corresponding output videos;
receiving a candidate set comprising a temporal sequence of image frames of an arbitrary scene captured via an imaging device;
applying the predictive model to the candidate set to predict a quality score;
the quality score defining a subjective quality of a corresponding output video that can be generated by the image sequence processing algorithm from the candidate set; and
if the quality score exceeds a predetermined threshold, automatically applying the image sequence processing algorithm to generate the corresponding output video from the candidate set.

12. The method of claim 11 further comprising a plurality of selectable quality models, each quality model trained, in part, on human quality ratings received from a particular demographic group.

13. The method of claim 11 further comprising:
determining an image sequence type of the candidate set; and
applying a quality model trained, in part, on similar types of image sequences to predict the quality score.

14. The method of claim 11 further comprising:
a plurality of different image sequence processing algorithms;
a separate quality model trained for each of the different image sequence processing algorithm; and
automatically selecting and applying a corresponding quality model to predict the quality score in response to a user selection of one of a particular one of the different image sequence processing algorithms.

15. The method of claim 14 further comprising defining a different set of features to be extracted for each of the different image sequence processing algorithms.

16. The method of claim 11 further comprising estimating motions for each training set and providing the estimated motions as one of the extracted features for use in training the quality model.

17. The method of claim 16 further comprising estimating motions for the candidate set and providing the estimated motions as one of the extracted features for use by the quality model in generating the quality score.

18. A computer-readable storage device having computer-executable instructions stored thereupon which, when executed by a computer, cause the computer to:
receive a predictive model, the predictive model automatically generated from a combination of features extracted from a plurality of arbitrary temporal sequence of image frames and human subjective quality ratings of one or more output videos generated from the temporal sequences by an image sequence processing algorithm;
receive a candidate set comprising a temporal sequence of image frames of an arbitrary scene;
apply the predictive model to the candidate set to generate a quality score;
the quality score defining a predicted subjective quality of a corresponding output video that can be generated by the image sequence processing algorithm from the candidate set; and
if the predicted quality score exceeds a predetermined threshold, automatically apply the image sequence processing algorithm to generate and output the corresponding output video from the candidate set.

19. The computer-readable storage device of claim 18 further comprising:
determining an image sequence type of the candidate set; and
applying a quality model trained, in part, on similar types of image sequences to predict the quality score.

20. The computer-readable storage device of claim 18 further comprising:
a plurality of different image sequence processing algorithms;
a separate quality model trained for each of the different image sequence processing algorithm; and
automatically selecting and applying a corresponding quality model to predict the quality score in response to a user selection of one of a particular one of the different image sequence processing algorithms.
